(19) United States
(12) Patent Application Publication
(10) Pub. No.: US 2017/0123595 A1
(43) Pub. Date: May 4, 2017

(54) OPTICAL TOUCH DEVICE AND OPERATION METHOD THEREOF

(71) Applicant: BOE TECHNOLOGY GROUP CO., LTD., Beijind (CN)

(72) Inventors: Xiangxiang Zou, Beijing (CN); Zezhou Yang, Beijing (CN)

(73) Assignee: BOE TECHNOLOGY GROUP CO., LTD., Beijing (CN)

(21) Appl. No.: 15/030,577

(22) PCT Filed: Dec. 10, 2015
(86) PCT No.: PCT/CN2015/096932

§ 371 Date: Apr. 19, 2016

(30) Foreign Application Priority Data
Jun. 5, 2015 (CN) 201510303611.8

(51) Int. Cl. G06F 3/042

(52) U.S. Cl. CPC G06F 3/0428; G06F 2203/04109; G06F 2203/04108

(57) ABSTRACT

The present application provides an optical touch device comprising a light transmission layer having a first total internal reflection (TIR) surface and the second TIR surface, a light source beside the second TIR surface, a detector for detecting the light beam passed through the light transmission layer and transmitted into the detector, and a first reflector disposed between the light source and the light transmission layer, capable of reflecting the light beam emitted from the light source into the light transmission layer.

### CROSS-REFERENCE TO RELATED APPLICATION

This application claims priority to Chinese Patent Application No. 201510303611.8, filed Jun. 5, 2015, the contents of which are incorporated by reference in the entirety.

### FIELD OF THE INVENTION

The present invention generally relates to a touch control device, and more particularly, to an optical touch control device and an operation method thereof.

### BACKGROUND OF THE INVENTION

Conventional touch devices can be generally categorized into resistive, capacitive, optical, sound wave, and electromagnetic designs. In recent years, touch devices have been widely used in many electronic devices such as mobile phones, computer display panels, touch screens, satellite navigation devices, digital cameras, etc. A conventional optical touch device provides light to a sensing area, such that a light sensing element can sense the position of a touch point. When the user's finger enters the sensing space, the optical detectors can detect the finger and thereby accomplish touch detection.

In conventional optical touch devices, light utilization efficiency is low. Typically, autilization efficiency of less than 10% can be achieved in a conventional optical touch control device. Conventional touch devices requires higher intensity light sources or a greater number of light sources. Thus, conventional touch devices demand more power consumption in order to achieve optimized touch control function.

### SUMMARY

In one aspect, the present invention provides an optical touch device comprising a light transmission layer, a light source beside the second TIR surface, a detector beside the second TIR surface or the first TIR surface, and a first reflector disposed between the light source and the light transmission layer. The light transmission layer comprises a first total internal reflection (TIR) surface and the second TIR surface facing the first TIR surface. The light source is capable of emitting a light beam. When the light beam enters into the light transmission layer, the first TIR surface and the second TIR surface are capable of repeatedly totally reflecting the light beam in the light transmission layer, thereby confining the light beam between the first TIR surface and the second TIR surface. The detector is capable of detecting the light beam passed through the light transmission layer and transmitted into the detector. When a touch object contacts one of the TIR surfaces, a portion of the light beam passes through the touched TIR surface and the detector detects less amount of lights from the light transmission layer. The first reflector is capable of reflecting the light beam emitted from the light source into the light transmission layer at an angle to cause total reflection at the two TIR surfaces.

Optionally, the light source and the detector are disposed beside the same TIR surface. Optionally, the first reflector comprises a first prism. Optionally, the first prism is a first triangular prism, the hypotenuse of the first triangular prism is inclined with respect to the light transmission layer at a first predetermined angle, and one of the square edges is disposed beside the second TIR surface. Optionally, the first reflector further comprises a first reflection layer, capable of blocking light not reflected by the first prism into the light transmission layer and passed through the first prism. Optionally, the first reflector further comprises a first reflection layer disposed on top of the hypotenuse of the first triangular prism, capable of blocking light not reflected by the first prism into the light transmission layer and passed through the first prism. Optionally, the first triangular prism comprises a plurality of protruding structures along the hypotenuse of the first triangular prism. Optionally, the sides of the protruding structures are triangular and extend in a predetermined direction. Optionally, the first reflector further comprises a first reflection layer disposed on top of the protruding structures, capable of blocking light not reflected by the first prism into the light transmission layer and passed through the first prism. Optionally, the optical touch device further comprises a display unit.

Optionally, the optical touch device further comprises a second reflector disposed between the light transmission layer and the detector, capable of reflecting the light beam passed through the light transmission layer into the detector. Optionally, the second reflector comprises a second prism. Optionally, the second prism is a second triangular prism, the hypotenuse of the second triangular prism is inclined with respect to the light transmission layer at a second predetermined angle, and one of the square edges is disposed beside one of the TIR surfaces. Optionally, the second reflector further comprises a second reflection layer, capable of blocking light not reflected by the second prism into the detector and passed through the second prism. Optionally, the second reflector further comprises a second reflection layer disposed on the hypotenuse of the second triangular prism, capable of blocking light not reflected by the second prism into the detector and passed through the second prism. Optionally, the second triangular prism comprises a plurality of protruding structures along the hypotenuse of the second triangular prism, and the sides of the protruding structures are triangular and extend in a predetermined direction.

Optionally, in either the first prism or the second prism or both, the sides of the protruding structures are of triangular shape and extend in a predetermined direction. Optionally, the triangular sides of the protruding structures have base angles less than 90 degree. Optionally, each base angle is substantially 70 degree. Optionally, in either the first prism or the second prism or both, the length of the prism square edge parallel to the TIR surfaces is substantially equal to or less than 50 millimeters. Optionally, the length of the square edge is substantially equal to 10 millimeters.

Optionally, in any of the above-mentioned optical touch display device, the light utilization efficiency from the light source to the detector using the optical touch devices of the present invention is higher than 10%, higher than 15%, higher than 20%, higher than 25%, higher than 30%, higher than 31%, higher than 32%, higher than 33%. In some embodiments, the light utilization efficiency from the light source to the detector using the optical touch devices of the present invention is in the range of 10-40%, 20-35%, 25-35%, 20-40%, 25-40%, 30-35%, or 30-40%. Optionally, a plurality of the light sources and a plurality of the detectors are disposed alternately and spaced apart around the edges of the light transmission layer.

In another aspect, the present invention provides a method of operating an optical touch display device. The method comprises providing an optical touch device of the present invention; employing at least on touch object to contact the light transmission layer so that a total internal reflection effect of the first total internal reflection surface to the light beam is spoiled, a portion of the light beam passes through the TIR surface. The detector detects a touch motion of the touch object when the detector detects less amount of lights from the light transmission layer.

Optionally, the method further comprises suspending the touch object above the light transmission layer; moving the touch object to a suitable location, and contacting the touch object with the light transmission layer to complete the touch motion.

### BRIEF DESCRIPTION OF THE FIGURES

FIG. 1 is a diagram illustrating the structure of an optical touch device according to an embodiment of the present invention.

FIG. 2 is a diagram illustrating the structure of a first reflector according to an embodiment of the present invention.

FIG. 3a shows a front view of a first optical triangular prism according to an embodiment of the present invention.

FIG. 3b shows a bottom plan view of a first optical triangular prism according to an embodiment of the present invention.

FIG. 4 shows a bottom plan view of a first optical triangular prism according to another embodiment of the present invention.

FIG. 5 is a diagram illustrating the structure of a second reflector according to an embodiment of the present invention.

FIG. 6a shows a front view of a second optical triangular prism according to an embodiment of the present invention.

FIG. 6b shows a bottom plan view of a second optical triangular prism according to an embodiment of the present invention.

FIG. 7 shows a bottom plan view of a second optical triangular prism according to another embodiment of the present invention.

FIG. 8 shows a top plan view of an optical touch control device according to an embodiment of the present invention.

FIG. 9 shows a top plan view of another optical touch control device according to another embodiment of the present invention.

FIG. 10 is a diagram illustrating the structure an optical touch control device according to an embodiment of the present invention.

FIG. 11 is a diagram illustrating the structure an optical touch control device according to another embodiment of the present invention.

### DETAILED DESCRIPTION OF THE INVENTION

The disclosure will now described more specifically with reference to the following embodiments. It is to be noted that the following descriptions of preferred embodiments are presented herein for purpose of illustration and description only. It is not intended to be exhaustive or to be limited to the precise form disclosed.

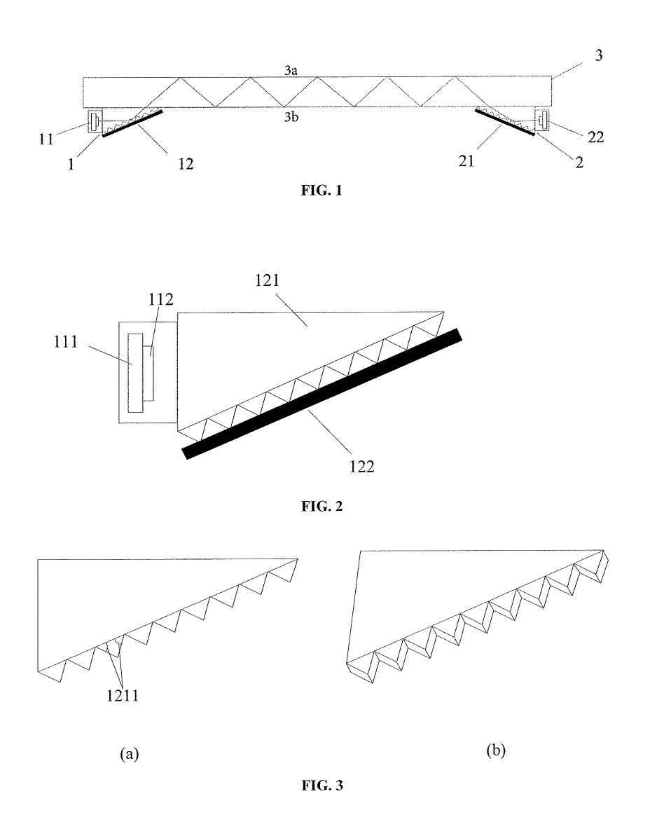

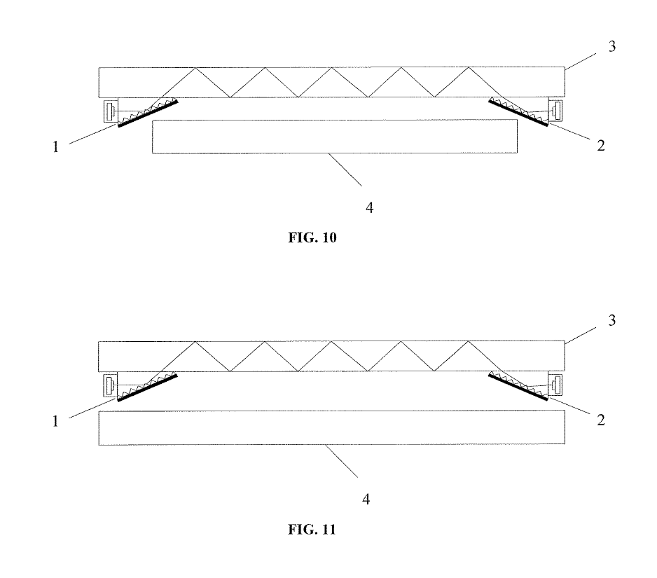

FIG. 1 is a cross-sectional schematic view of an optical touch device according to an embodiment of the invention. Referring to FIG. 1, an optical touch device in the embodiment includes a display unit (e.g., display panel 4 in FIG. 10 and FIG. 11), at least one transmission unit 1 comprising a light source 11 and a first reflector 12, a light transmission layer 3, and at least one receiving unit 2 comprising a detector 22 and a second reflector 21.

The light transmission layer 3 is disposed beside the display unit, for example, on top of a display unit. The light transmission layer 3 is capable of reflecting the light by total reflection, and transmitting the light into the detector 22. The light transmission layer 3 has a first total internal reflection (TIR) surface 3a and a second TIR surface 3b opposite to and facing the first TIR surface 3a, and two terminals distal to each other. The first TIR surface 3a and the second TIR surface 3b are capable of repeated totally reflecting the light beam transmitted into the light transmission layer 3, thus confining the light beam between the two TIR surfaces.

When touch control happens on the light transmission layer 3, e.g., when a touch object (e.g., a user's finger or a tip of a stylus) contacts the first TIR surface 3a, the surface refractive index of the first TIR surface changes. The TIR effect of the first TIR surface 3a to the light beam is spoiled. A portion of the light beam passes through the first TIR surface 3a. As a result, the intensity of light received by the detector 22 decreases. The detector 22 can thus determine the position of the touch control point based on the intensities of light received by the detector 22 and light transmitted by the light source.

The light source 11 is disposed beside one of the TIR surfaces, for example, the second TIR surface 3b as shown in FIG. 1. Preferably the light source 11 is disposed proximal to one terminal of the light transmission layer 3. The light source 11 is capable of emitting a light beam for transmitting into the light transmission layer 3.

The detector 22 is disposed beside one of the TIR surfaces, for example, the second TIR surface 3b as shown in FIG. 1. Preferably, the detector 22 is disposed proximal to one terminal of the light transmission layer 3, which terminal is distal to the terminal where the light source is disposed at. The detector 22 can be dispose on the same side with respect to the light source or on a different side of the light transmission layer 3. The detector 22 is capable of detecting the light beam passed through the light transmission layer 3 and transmitted into the detector 22.

The first reflector 12 is disposed between the light source 11 and the light transmission layer 3. The first reflector 12 is capable of reflecting the light beam emitted from the light source 11 into the light transmission layer 3. With the addition of the first reflector 12, more light from the light source 11 can be reflected by the first reflector 12 into the light transmission layer 3, consequently more light enters into the detector 22 by total reflection within the light transmission layer 3. The addition of the first reflector 12 enhances the light utilization efficiency, saving the numbers of LEDs needed for optimized results and decreasing the power consumption of the optical touch control device. The first reflector 12 can be inclined with respect to the light transmission layer 3 at a first predetermined angle. Optionally, the first reflector 12 is secured to the light source 11. For example, one end of the first reflector 12 can be connected to the light source 11.

The second reflector 21 is disposed between the light transmission layer 3 and the detector 22. The second reflector 21 is capable of reflecting the light beam passed through the light transmission layer 3 into the detector 22. With the addition of the second reflector 21, more light from the light transmission layer 3 can be reflected by the second reflector 21 into the detector 22. The addition of the second reflector 21 enhances the light utilization efficiency, saving the numbers of LEDs needed for optimized results and decreasing the power consumption of the optical touch control device. The second reflector 21 can be inclined with respect to the light transmission layer 3 at a second predetermined angle. Optionally, the second reflector 21 is secured to the detector 22. For example, one end of the second reflector 21 can be connected to the detector 22.

The light source 11 can be a visible light source or a non-visible light source. For example, the light source 11 can be an infrared LEDs or infrared laser diodes. The light beam can be a visible light beam or a non-visible light beam, e.g., an infrared light beam. The detector 22 can be any suitable optical detectors. For example, the detectors 2 can be a charge coupled devices (CCDs), a complementary metal-oxide-semiconductor sensors (CMOS sensors), a photomultiplier tubes (PMTs), or other optical detectors.

The light transmission layer 3 can be, for example, a transparent layer (e.g., a cover glass) having a refractive index suitable for totally reflecting the light beam entering into the light transmission layer 3. Total internal reflection occurs when light encounters a boundary between different materials at an angle greater than a critical angle. When light does not encounter the boundary at an angle greater than the critical angle, the light will be partially refracted and partially reflected at the boundary. However, refraction will stop and all light will be internally reflected if the critical angle is exceeded. The ratio of the refractive index of the less dense medium compared to the refractive index of the denser medium determines the critical angle at the boundary between the different mediums. The refractive index of the light transmission layer 3 can be greater than the refractive index of air, which is very close to 1.0. Non-limiting examples of material for making the light transmission layer 3 include glass or polycarbonate, which are characterized by refractive indices of approximately 1.5 to 1.6. As such, the critical angle at the reflective face may be approximately thirty-nine degrees to forty-two degrees. Therefore, in such an embodiment, if reference light encounters the reflection face at greater than approximately thirty-nine to forty-two degrees, the reference light will be totally internally reflected. It should be understood that other materials may be used to construct the light transmission layer 3, and such materials may result in a different critical angle.

The display unit can be, for example, a liquid crystal display panel including an array substrate, a counter substrate, and a liquid crystal layer disposed between the array substrate and the counter substrate. The array substrate can be, for example, a thin film transistor array substrate. The counter substrate can be, for example, a color filter array substrate. The display unit can be other types of display units, for example, a light emitting diode array panel, an organic light emitting diode array panel, a plasma display panel, or a cathode ray tube.

The first reflector 12 and the second reflector 21 can be a planar or non-planar reflector. For example, the reflector can comprise a wire grid, a wire mesh, a SM patch, a reflective prism, or a combination of prisms. The prism can be, for example, a triangular prism, a rectangular prism, a truncated right angle prism, a pentaprism, or a roofed pentaprism.

FIG. 2 is a cross-sectional schematic view of a first reflector 12 according to an embodiment of the invention. Referring to FIG. 2, the first reflector 12 in the embodiment includes a first optical triangular prism 121 and a first reflection layer 122. The first optical triangular prism 121 is disposed proximal to the light source so that a light beam from the light source can be reflected by the first optical triangular prism 121 and transmitted into the light transmission layer 3. A side of the first reflector 12 can be inclined with respect to the light transmission layer 3. In FIG. 2, the hypotenuse side of the first triangular prism 121 is inclined with respect to the light transmission layer 3 at a first predetermined angle. The first predetermined angle can be set by changing the length of the first triangular prism 121.

The first reflector 12 can further comprises a first reflection layer 122 disposed at a position so as to block light not reflected by the first triangular prism 121 into the light transmission layer 3 but passed through the prism, e.g., light transmitting out from the hypotenuse side of the prism. To further enhance the light utilization efficiency, a first reflection layer 122 can be disposed proximal to the prism, for example, close to or on the hypotenuse of the first triangular prism 121.

The light source 11 can comprise a first printed circuit board (PCB) 111 and a transmission terminal 112. The transmission terminal 112 can be disposed at a side of the first PCB 111 proximal to the first optical triangular prism 121. The surfaces of the first PCB 111 and the transmission terminal 112 can be both perpendicular to the surface of the light transmission layer 3 so as to transmitting as much light from the transmission terminal 112 into the first optical triangular prism 121, further enhancing light utilization efficiency.

FIG. 5 is a cross-sectional schematic view of a second reflector 21 according to an embodiment of the invention. Referring to FIG. 5, the second reflector 21 in the embodiment includes a second optical triangular prism 211 and a second reflection layer 212. The second optical triangular prism 211 is disposed proximal to the detector so that a light beam from the light transmission layer 3 can be reflected by the second optical triangular prism 211 and transmitted into the detector. One side of the second reflector 21 can be inclined with respect to the light transmission layer 3. In FIG. 5, the hypotenuse side of the second triangular prism 211 is inclined with respect to the light transmission layer 3 at a second predetermined angle. The second predetermined angle can be set by changing the length of the second triangular prism 211. The first and second predetermined angles can be different or the same.

The second reflector 21 can further comprises a second reflection layer 212 disposed at a position so as to block light not reflected by the second triangular prism 211 into the detector 22 but passed through the prism, e.g., light transmitting out from the hypotenuse side of the prism. To further enhance the light utilization efficiency, a second reflection layer 212 can be disposed proximal to the prism, for example, close to or on the hypotenuse of the second triangular prism 211.

The detector 22 can comprise a second printed circuit board (PCB) 221 and a receiving terminal 222. The receiving terminal 222 can be disposed at a side of the second PCB 221 proximal to the second optical triangular prism 211. The surfaces of the second PCB 221 and the receiving terminal 222 can be both perpendicular to the surface of the light transmission layer 3 so as to transmitting as much light from the second triangular prism 211 into the receiving terminal 222, further enhancing light utilization efficiency.

The first and/or second prism can have a plurality of protruding structures along the hypotenuse. The protruding structure can be of any shape or structure, for example, a cone, a triangular prism, a rectangular prism, a cylinder, a hexagonal prism, a pyramid shape, or a V-cut structure. The sides of the protruding structures can be of any shape, for example, square, parallelogram, trapezoid, half circle, half ellipse, rectangular, or triangular shape, and extend in a predetermined direction. The sides of the protruding structures can have two base angles. For example, one base angle can be a right angle or an obtuse angle and the other base angle is an acute angle. Alternatively, both base angles are acute angles, for example, 40 degree, 50 degree, 60 degree, 70 degree, or 80 degree. These two base angles can be the same or different. For example, the pair of base angles can be 60 degree and 60 degree, 70 degree and 70 degree, 60 degree and 70 degree, 70 degree and 60 degree, 70 degree and 80 degree, 50 degree and 80 degree, etc. In some embodiments, the protruding structures can have a V-cut structure.

The prism has two square edges, one of which can be disposed parallel to the TIR surfaces 3a and/or 3b of the light transmission layer 3 as shown in FIG. 1. The length of the square edge parallel to the TIR surfaces, e.g., the second TIR surface 3b, can be set at various values according to the design of the optical touch device. In general, the length of the square edge ranges from 1 mm to 200 mm, e.g., 1 mm to 100 mm, 10 mm to 100 mm, 1 mm to 50 mm, 10 mm to 50 mm, or 10 mm to 30 mm. When the optional touch device of the present invention is used for making touch control panels, the length of the square edge can be set to a value so as to minimize the width of the touch control panel frame. For example, the length of the square edge of the first and/or second prism can be less than 50 mm, 40 mm, 30 mm, 20 mm, or 10 mm.

FIG. 3a shows a front view of a first optical triangular prism according to an embodiment of the present invention, FIG. 3b shows a bottom plan view of a first optical triangular prism according to an embodiment of the present invention. Referring to FIG. 3a and FIG. 3b, the first optical triangular prism in the embodiment includes a plurality of protruding structures along the hypotenuse of the first triangular prism. The sides of the protruding structures can have two base angles 1211 as shown in FIG. 3a.

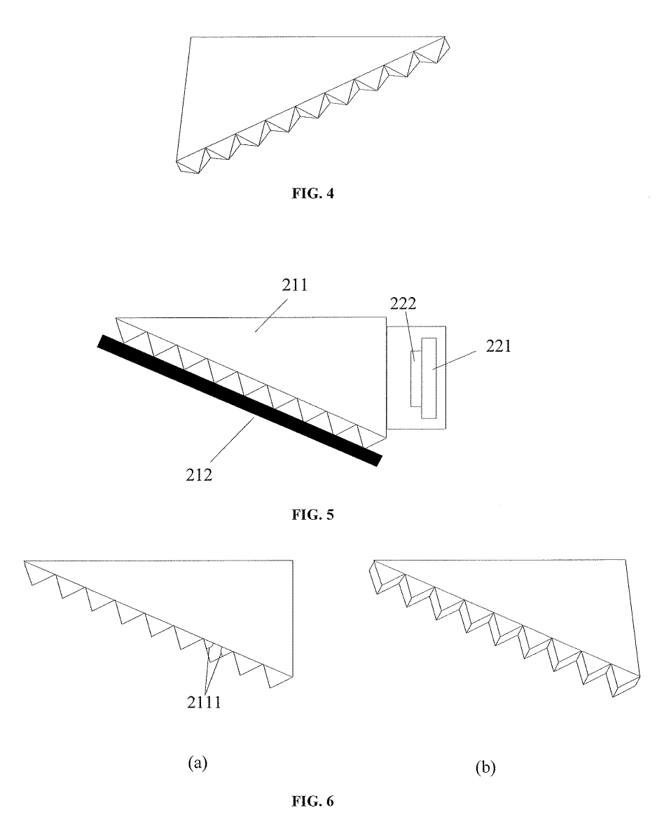

FIG. 4 shows a bottom plan view of a first optical triangular prism according to another embodiment of the present invention. Referring to FIG. 4, the first optical triangular prism in the embodiment includes a plurality of pyramid-shape protruding structures along the hypotenuse of the first triangular prism. The sides of the protruding structures can have two base angles 1211 as discussed above.

FIG. 6a shows a front view of a second optical triangular prism according to an embodiment of the present invention, FIG. 6b shows a bottom plan view of a second optical triangular prism according to an embodiment of the present invention. Referring to FIG. 6a and FIG. 6b, the second optical triangular prism in the embodiment includes a plurality of protruding structures along the hypotenuse of the second triangular prism. The sides of the protruding structures can have two base angles 2111 as shown in FIG. 6a.

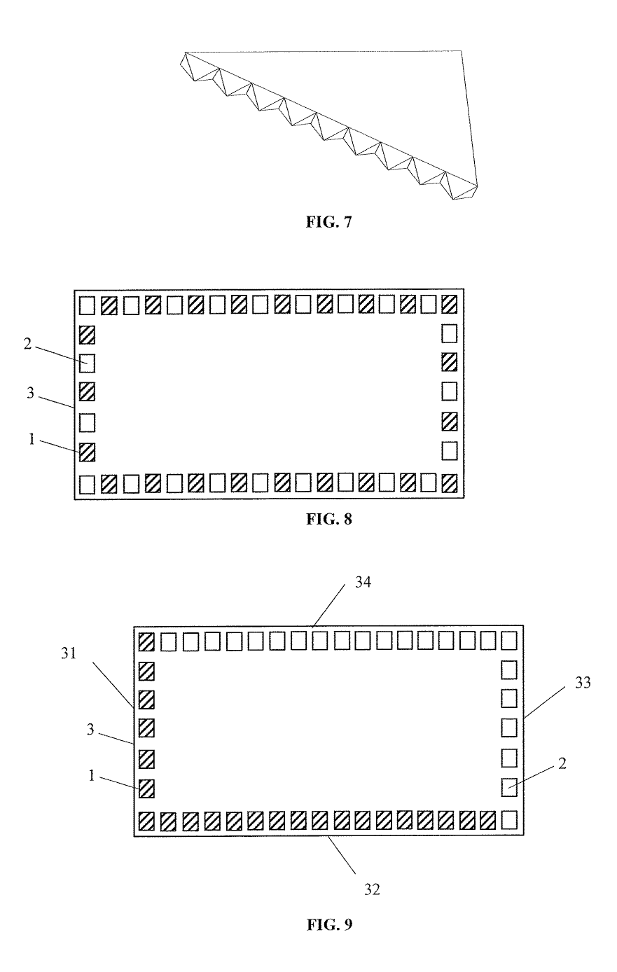

FIG. 7 shows a bottom plan view of a second optical triangular prism according to another embodiment of the present invention. Referring to FIG. 7, the second optical triangular prism in the embodiment includes a plurality of pyramid-shape protruding structures along the hypotenuse of the second triangular prism. The sides of the protruding structures can have two base angles 2111 as discussed above.

In view of the foregoing, the light utilization efficiency of an optical touch device can be varied by adjusting parameters of the components of the optical touch device, including, for example, the length of the square edge parallel to the TIR surface and the base angles of the sides of the protruding structures of a prism. Light utilization efficiencies of some exemplary optical touch devices are provided in Table 1 below:

TABLE 1
Light utilization efficiencies of some exemplary optical touch devices
having different square edge lengths parallel to the TIR surface and
different base angles of the triangular sides of the protruding
structures in the first optical triangular prism.

| The length of the prism | Base angles of the triangular sides | | | |
|---|---|---|---|---|
| square edge parallel to the | of the protruding structures | | | |
| TIR surface | 60°/60° | 60°/70° | 70°/70° | 70°/60° |
| 10 mm | 0.3209 | 0.3118 | 0.3359 | 0.3256 |
| 20 mm | 0.2406 | 0.2557 | 0.2730 | 0.2588 |
| 30 mm | 0.2126 | 0.2346 | 0.2492 | 0.2234 |

Thus, as compared to a conventional optical device, an optimized light utilization efficiency can be achieved using the optical touch devices according to the present invention. For example, in some embodiments, the light utilization efficiency from the light source to the detector using the optical touch devices of the present invention is higher than 10%, higher than 15%, higher than 20%, higher than 25%, higher than 30%, higher than 31%, higher than 32%, higher than 33%. In some embodiments, the light utilization efficiency from the light source to the detector using the optical touch devices of the present invention is in the range of 10-40%, 20-35%, 25-35%, 20-40%, 25-40%, 30-35%, or 30-40%.

FIG. 8 shows a top plan view of an optical touch device according to an embodiment of the present invention. Referring to FIG. 8, an optical touch device in the embodiment includes a plurality of transmission units 1 and a plurality of receiving units 2 disposed alternately and spaced apart around the edges of the light transmission layer 3. Each transmission unit 1 on one perimeter is disposed opposite to a corresponding receiving unit 2 placed on an opposite perimeter. FIG. 9 shows a top plan view of another optical touch device according to an embodiment of the present invention. Referring to FIG. 9, an optical touch device in the embodiment includes a plurality of transmission units 1 disposed spaced apart on the first perimeter 31 and the second perimeter 32, and a plurality of receiving units 2 disposed spaced apart on the third perimeter 32 and the fourth perimeter 34. The first perimeter 31 faces and is opposite to the third perimeter 33, and the second perimeter 32 faces and is opposite to the fourth perimeter 34. Each transmission unit 1 on one perimeter is disposed opposite to a corresponding receiving unit 2 placed on an opposite perimeter. An optical touch device can have other arrangements of the transmission units 1 and receiving units 2. The arrangements can be optimized according to specific requirements of the device.

Similarly, the size of the display panel relative to the size of the light transmission layer 3 can be varied and optimized according to the specific requirements of the device. The sizes can the same or different. For example, the size of the display panel can be smaller than the size of the light transmission layer 3. FIG. 10 shows the structure an optical touch device according to an embodiment of the present invention. Referring to FIG. 10, the size of the display panel 4 is smaller than the size of the light transmission layer 3. FIG. 11 shows the structure an optical touch device according to another embodiment of the present invention. Referring to FIG. 11, the size of the display panel 4 is the same as the size of the light transmission layer 3.

In another aspect, the present invention provides a method of operating an optical touch display device, comprising providing an optical touch device; employing at least on touch object to contact the light transmission layer so that a total internal reflection effect of the first total internal reflection surface to the light beam is spoiled, a portion of the light beam passes through the TIR surface. The detector detects a touch motion of the touch object when the detector detects less amount of light from the light transmission layer. In some embodiments, the method further comprises suspending the touch object above the light transmission layer; moving the touch object to a suitable location, and contacting the touch object with the light transmission layer to complete the touch motion. It should be noted that a single touch object or a plurality of touch objects can be used in the present invention, i.e., the number of the touch objects is not limited. In some embodiments, a plurality of touch objects can be adopted to simultaneously or not simultaneously contact the light transmission layer 3 so as to produce single point or multi-point touch.

The suspending and moving steps of the embodiments discussed above is not always required for executing the operation method of the invention. For example, when the user is certain about the touch location, the touch object can be directly contacted with the light transmission layer 3. In that case, it is not necessary to suspend the touch object above the light transmission layer 3.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An optical touch device comprising:
a light transmission layer comprising a first total internal reflection (TIR) surface and the second TIR surface facing the first TIR surface;
a light source beside the second TIR surface for emitting a light beam; wherein, when the light beam enters into the light transmission layer, the first TIR surface and the second TIR surface are capable of repeatedly totally reflecting the light beam in the light transmission layer, confining the light beam between the first TIR surface and the second TIR surface;
a detector beside the second TIR surface or the first TIR surface, for detecting the light beam passed through the light transmission layer and transmitted into the detector; wherein, when a touch object contacts one of the TIR surfaces, a portion of the light beam passes through the touched TIR surface and the detector detects less amount of lights from the light transmission layer; and
a first reflector disposed between the light source and the light transmission layer, capable of reflecting the light beam emitted from the light source into the light transmission layer at an angle to cause total reflection at the two TIR surfaces.

2. The optical touch device according to claim 1, wherein the light source and the detector are disposed beside the same TIR surface.

3. The optical touch device according to claim 1, wherein the first reflector comprises a first prism.

4. The optical touch device according to claim 3, wherein the first prism is a first triangular prism, the hypotenuse of the first triangular prism is inclined with respect to the light transmission layer at a first predetermined angle, and one of the square edges is disposed beside the second TIR surface.

5. The optical touch device according to claim 1, wherein the first reflector further comprises a first reflection layer, capable of blocking light not reflected by the first prism into the light transmission layer and passed through the first prism.

6. The optical touch device according to claim 4, wherein the first reflector further comprises a first reflection layer disposed on top of the hypotenuse of the first triangular prism, capable of blocking light not reflected by the first prism into the light transmission layer and passed through the first prism.

7. The optical touch device according to claim 4, wherein the first triangular prism comprises a plurality of protruding structures along the hypotenuse of the first triangular prism.

8. The optical touch device according to claim 7, wherein the first reflector further comprises a first reflection layer disposed on top of the protruding structures, capable of blocking light not reflected by the first prism into the light transmission layer and passed through the first prism.

9. The optical touch device according to claim 1, further comprising a second reflector disposed between the light transmission layer and the detector, capable of reflecting the light beam passed through the light transmission layer into the detector.

10. The optical touch device according to claim 9, wherein the second reflector comprises a second prism.

11. The optical touch device according to claim 10, wherein the second prism is a second triangular prism, the hypotenuse of the second triangular prism is inclined with respect to the light transmission layer at a second predetermined angle, and one of the square edges is disposed beside one of the TIR surfaces.

12. The optical touch device according to claim 9, wherein the second reflector further comprises a second reflection layer, capable of blocking light not reflected by the second prism into the detector and passed through the second prism.

13. The optical touch device according to claim 11, wherein the second reflector further comprises a second reflection layer disposed on the hypotenuse of the second triangular prism, capable of blocking light not reflected by the second prism into the detector and passed through the second prism.

14. The optical touch device according to claim 11, wherein the second triangular prism comprises a plurality of protruding structures along the hypotenuse of the second triangular prism.

15. The optical touch device according to claim 7, wherein the sides of the protruding structures are of triangular shape and extend in a predetermined direction.

16. The optical touch device according to claim 15, wherein each base angle is substantially 70 degree.

17. The optical touch device according to claim 4, wherein the length of the prism square edge parallel to the TIR surface is substantially equal to or less than 50 millimeters.

18. The optical touch device according to claim 17, wherein the length of the square edge is substantially equal to 10 millimeters.

19. The optical touch device according to claim 1, wherein a plurality of the light sources and a plurality of the detectors are disposed alternately and spaced apart around the edges of the light transmission layer.

20. The optical touch device according to claim 1, wherein the light utilization efficiency from the light source to the detector is higher than 20%.
